(19) United States
(12) Patent Application Publication
(10) Pub. No.: US 2021/0011453 A1
(43) Pub. Date: Jan. 14, 2021

(54) ELECTRIC LIFTING TABLE AND CONTROL METHOD THEREOF

(71) Applicant: LOCTEK ERGONOMIC TECHNOLOGY CORP., Ningbo (CN)

(72) Inventors: Lehong XIANG, NINGBO (CN); Xiang LI, NINGBO (CN); Jiadong JIN, NINGBO (CN)

(73) Assignee: LOCTEK ERGONOMIC TECHNOLOGY CORP.

(21) Appl. No.: 16/888,623

(22) Filed: May 29, 2020

(30) Foreign Application Priority Data
Jul. 10, 2019 (CN) 201910619117.0

(51) Int. Cl. G05B 19/402; A47B 9/00; G01P 15/18; G01H 11/06

(52) U.S. Cl. CPC G05B 19/402; A47B 9/00; G05B 2219/40376; G01H 11/06; A47B 2200/004; G01P 15/18

(57) ABSTRACT

The present invention relates to the technical field of lifting platforms, in particular to an electric lifting table and a control method thereof; which comprising: a table board (1), one side of which is provided with at least one table leg (2); a lifting mechanism, arranged within the table leg (2); a controller (3), connected to the table board (1), and electrically connected to the lifting mechanism; and it further comprises a vibration sensor, electrically connected with the controller, and the vibration sensor is configured to sense vibration of the table board when one knocks on the table board, and the controller is configured to control the lifting mechanism to act according to the behavior that the user knocks on the table board sensed by the vibration sensor, which is user-friendly to operate and low in cost.

### CROSS-REFERENCE TO RELATED APPLICATIONS

This application claims priority to Chinese Patent Application No. 201910619117.0 with a filing date of Jul. 10, 2019. The content of the aforementioned applications, including any intervening amendments thereto, are incorporated herein by reference.

### TECHNICAL FIELD

The present disclosure relates to the technical field of lifting platforms, in particular to a an electric lifting table and a control method thereof.

### BACKGROUND

An electric lifting table, such as a height-adjustable desk, a dining table, an office table and the like, is often used at home or in an office. Generically speaking, the electric lifting table in the prior art is provided with a hand controller by which a user can control the electric lifting table. However, the hand controller usually needs to be mounted at some fixed location, so when needed, the user has to operate the hand controller at the fixed location, obviously, the above operation is neither convenient nor user-friendly. In addition, as a portion of the whole electric lifting table, the hand controller occupies certain cost, thereby increasing the whole cost of the electric lifting table.

### SUMMARY

One objective of the present disclosure is to overcome the shortcomings of the prior arts by providing an electric lifting table that is user-friendly to operate and low in cost.

The technical solution adopted to resolve the above technical problem is to provide an electric lifting table, that comprises:

a table board, one side of which is provided with at least one table leg;
a lifting mechanism, arranged within the table leg;
a controller, connected to the table board, and electrically connected to the lifting mechanism;
it further comprises:
a vibration sensor, electrically connected with the controller;

and the vibration sensor is configured to sense vibration of the table board when one knocks on the table board, and the controller is configured to control the lifting mechanism to act according to the behavior that the user knocks on the table board sensed by the vibration sensor.

In a preferred embodiment, the vibration sensor is a multi-axis acceleration sensor.

In a preferred embodiment, the vibration sensor is in rigid connection with the table board.

As compared to the prior art, the electric lifting table adopting the above structure has the following advantages: a vibration sensor is arranged for detecting vibration of a table board, then the lifting mechanism is controlled to act according to different vibrations of the table board, in such a case, a hand controller on the electric lifting table is not needed any longer, and control becomes easy and more user-friendly merely with the help of a controller and a vibration sensor. Without any hand controller, cost is greatly lowered.

A detection effect becomes better if a six-axis acceleration sensor is used as the vibration sensor.

A good detection effect is resulted from a rigid connection between the vibration sensor and the table board.

The other technical problem to be settled by the present invention is to provide a user-friendly method for controlling the electric lifting table with low cost.

The other technical solution adopted to resolve the above technical problem is to provide a control method of the electric lifting table, and the electric lifting table comprises:

a table board, one side of which is provided with at least one table leg;

a lifting mechanism, arranged within the table leg;

a controller, connected to the table board, and electrically connected to the lifting mechanism;

a vibration sensor, electrically connected with the controller;

and the controller is configured to receive vibration of the table board generated when one knocks on the table board and sensed by the vibration sensor, and then control the lifting mechanism to act in accordance with the received table board vibration generated when the user knocks on the table board. Preferably, the control method of the electric lifting table comprises the following steps:

S1, setting different control modes of the lifting mechanism corresponding to different table board vibrations as a result of different knocking modes of users;

S2, after starting control of the electric lifting table, detecting the table board vibration by the vibration sensor; if table board vibration generated when one knocks on the table board is not detected, going back to S2 to continue detecting; if table board vibration generated when one knocks on the table board is detected, transmitting table board vibration information to the controller, and then skipping to S3;

S3, acquiring a corresponding control mode of the lifting mechanism, by the controller according to the table board vibration information acquired in S2 and settings in S1, and controlling the lifting mechanism, by the controller according to the acquired control mode.

Preferably, the table board vibration generated when one knocks on the table board in S1 is determined by detecting vibration parameters, and the vibration parameters include vibration number of times and/or frequency and/or intensity.

Preferably, there also needs to set a table board vibration to activate the controller in S1; further, S2 also comprises the following steps:

S21, detecting the table board vibration generated when one knocks on the table board by the vibration sensor; if the control mode corresponding to the detected table board vibration is just the mode for activating the controller, activating the controller, and then starting control of the electric lifting table; if the control mode corresponding to the detected table board vibration is not the mode for activating the controller, continuing detecting.

Preferably, when no table board vibration is detected by the vibration sensor during the period of time of X since the last control behavior of the controller, the controller is controlled to be dormant, and control on the electric lifting table is closed.

Preferably, in S2, if table board vibration is detected, detection then needs to last for the period of time of Y, and then table board vibration information detected within the period of time of Y is transmitted to the controller.

Preferably, in S3, when the controller controls the lifting mechanism to operate, if table board vibration is detected by the vibration sensor, the controller controls the lifting mechanism to stop operation.

As compared to the prior art, the present invention adopting the abovementioned method has the following advantages: a vibration sensor is arranged for detecting the table board vibration, and then the lifting mechanism is controlled to act according to different table board vibrations, therefore, the electric lifting table is free from a hand controller, and is convenient and user-friendly to control merely with the help of a controller and a vibration sensor. Without any hand controller, cost is greatly reduced.

By corresponding table board vibrations to the specific control modes of the lifting mechanism, and then controlling the lifting mechanism to act according to the table board vibrations detected by the vibration sensor, a hand controller is not used any longer for control, therefore, control is more user-friendly and convenient. Further, the whole cost of the electric lifting table is reduced.

By controlling the lifting mechanism through one or a combination of vibration number of times, frequency and intensity, control accuracy is high, and control type is various.

A step of activating the controller is added, therefore, in case of no activation, no matter how to knock on the table board, the lifting mechanism is not controlled to act so as to prevent false triggering.

If no vibration for control is detected within a period of time after activation, the controller is controlled to be dormant so as to prevent false triggering.

If table board vibration is detected, detection needs to last for a period of time so as to avoid misjudgment due to too short detection time.

When the controller controls the lifting mechanism to operate after activated, i.e., to ascend or descend, if table board vibration is detected again, the lifting mechanism is stopped. Therefore, control is convenient and user-friendly.

### BRIEF DESCRIPTION OF THE DRAWINGS

FIG. 1 shows a schematic structural diagram of an electric lifting table of the present invention.

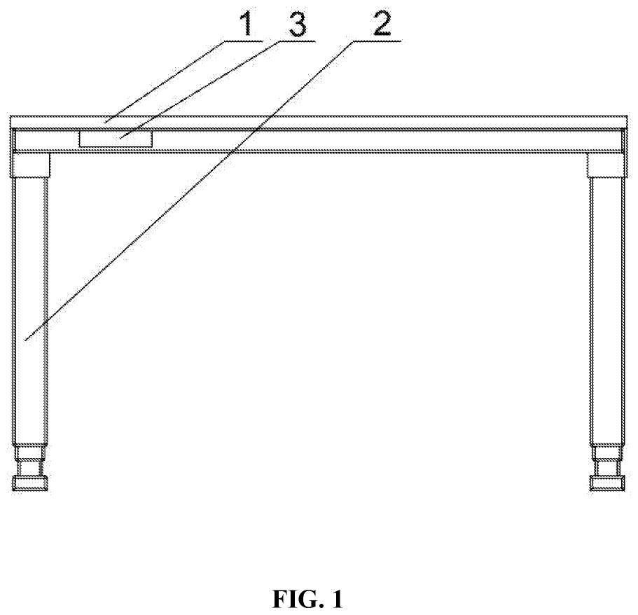

FIG. 2 shows a connection block diagram of the electric lifting table of the present invention.

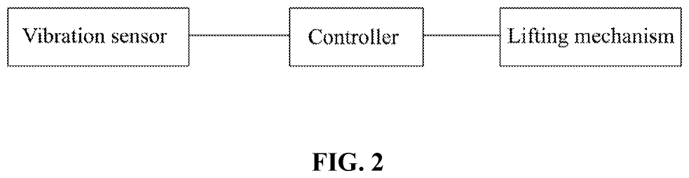

Reference numerals denote that: 1, table board; 2 table leg; 3 controller.

### DETAILED DESCRIPTION OF THE EMBODIMENTS

The present invention will be further described hereinafter by referring to the following embodiments, but is not limited thereto.

An electric lifting table comprises a table board 1, two table legs 2 at two sides of the table board 1, a lifting mechanism arranged within the table leg 2, a controller 3 connected to the table board 1, and a vibration sensor arranged on the table board 1, and the table board 1 is generally a panel that is common in the ordinary lifting table of the prior art and thus is not repeated; the table leg 2 comprises two portions between which it is retractable, and this arrangement belongs to the conventional settings of the lifting table in the prior art, and thus is not repeated any more; the lifting mechanism is generally arranged in the table leg for controlling stretching of the table leg so as to control height of the lifting table, and is electrically connected with a controller. The lifting mechanism mostly adopts a motor that also belongs to the conventional settings of the lifting table in the prior art and thus is not repeated anymore; the vibration sensor for detecting vibration of the table board is electrically connected with the controller, is in rigid connection with the table board, and mainly adopts a single-axis or multi-axis acceleration sensor in this embodiment, and vibration detection of the acceleration sensor is achieved by detecting quick change of a gravitational acceleration of the table board in its vertical direction; a common six-axis acceleration sensor is sold in the market, and thus is not further described in detail.

The controller 3 controls the lifting mechanism to act and receives table board vibration information transmitted from the vibration sensor, which belongs to the conventional settings of the lifting table in the prior art and thus is not further described in detail.

At the bottom of the table board 1, there is a control box in which the controller 3 is mounted, but the vibration sensor can be placed into the control box together with the controller 3 or independently mounted at the bottom of the table board.

Embodiment One: a control method of the above electric lifting table, comprising the following steps:

First, specific control modes of the lifting mechanism corresponding to table board vibrations are set. This embodiment has the following settings: knocking twice means activating a controller; when the controller is activated, knocking once means ascending of the lifting mechanism, while knocking twice means descending of the lifting mechanism; when in control of ascending or descending, the controller directly controls the lifting mechanism to stop movement as long as vibration of the table board is detected by the vibration sensor, and the behavior of knocking corresponds to vibration detected by the vibration sensor, that is, knocking twice is vibration twice.

Then, the electric lifting table is electrified and started, and in case of detecting that the table board is knocked twice, the controller is activated, and control of the electric lifting table is switched on. As particular knocking vibration is needed to activate the controller so as to start control of the electric lifting table, further if the vibration sensor fails to detect vibration of the table board within the period of time of X that is generally 0.5-1 min and is 1 min in this embodiment, the controller is controlled to be dormant and control of the electric lifting table is switched off. The above operations mean that as long as the controller is activated, table board vibrations detected subsequently are substantially produced from knocking on the table board by users, rather than false triggering of other forms, e.g., the table board is blocked or is borne with a weight, however, the above behaviors merely can produce once vibration rather than twice, and thus cannot activate the controller so as not to switch on control of the electric lifting table.

Next, when the controller is activated to start control of the electric lifting table, the vibration sensors continues detecting; in case of detecting that the table board is knocked once, i.e., the table board vibrates once, the controller controls the lifting mechanism to ascend; in case of detecting that the table board is knocked in the ascending process, i.e., the table board vibrates, the controller controls the lifting mechanism to stop ascending; in case of detecting that the table board is knocked twice, i.e., the table board vibrates twice, the controller controls the lifting mechanism to descend; in case of detecting that the table board is knocked in the descending process, i.e., the table board vibrates, the controller controls the lifting mechanism to stop descending.

Knocking once mentioned above means when the controller is activated, the vibration sensor detects vibration of the table board and continues detecting for the period of time of Y, but the vibration sensor never detects table board vibration during the period of time of Y once again. Knocking twice means when the controller is activated, the vibration sensor detects vibration of the table board and continues detecting for the period of time of Y, and the vibration sensor detects once table board vibration during the period of time of Y. Y is generally set at 0.1-3 s, and is 2 s in this embodiment.

In Embodiment Two, it differs from Embodiment One in set table board vibrations and specific control modes. In this embodiment, by taking knocking intensity as the main criteria, when knocking intensity is high, i.e., it is between levels B and C, the controller is first activated, then detection is continued; if knocking intensity is low, i.e., it is between levels of A and B, the lifting mechanism is controlled to ascend, and if knocking is detected in the ascending process, the lifting mechanism is controlled to stop ascending; if the knocking intensity is high, i.e., it is between levels of B and C, the lifting mechanism is controlled to descend, and if knocking is detected in the descending process, the lifting mechanism is controlled to stop descending. The behavior of knocking corresponds to vibration detected by the vibration sensor, that is, knocking once is vibration once.

In Embodiment Three, it differs from Embodiment One and Embodiment Two in set table board vibrations and specific control modes. In this embodiment, by taking knocking frequency as the main criteria, i.e., knocking speed, if knocking is quick, i.e., the knocking frequency is larger than D, the controller is first activated, then detection is continuously carried out; if detected knocking frequency is slow, i.e., the knocking frequency is smaller than D, the lifting mechanism is controlled by the controller to ascend; if knocking is detected in the ascending process, the lifting mechanism is controlled to stop ascending; if the detected knocking frequency is high and larger than D, the lifting mechanism is controlled to descend; and if knocking is detected in the descending process, the lifting mechanism is controlled to stop descending.

In Embodiment Four, it differs from Embodiment One in that in Embodiment Four, besides ascending, descending and stopping, the lifting mechanism is also controlled to move to some set location, e.g., in case of knocking three times in specific control, the lifting mechanism is controlled to move to a first location; in case of knocking four times, it is controlled to move to a second location, and the judgement principle of knocking three or four times is similar to that of knocking once or twice in Embodiment One.

It should be noted that, the above embodiments are merely illustrative, rather than restrictive, to the technical solution of the present invention. Although the present invention has been explained in detail by referring to the abovementioned embodiments, it should be understood by those skilled in the art that, modifications to the technical solution in the embodiments or equivalent substitutions of portion of technical features are allowed. These modifications or substitutions shall not cause the corresponding technical solutions to depart from the spirit and scope of the technical solutions of the embodiments of the present invention.

We claim:

1. An electric lifting table, comprising:
a table board (1), one side of which is provided with at least one table leg (2);
a lifting mechanism, arranged within the table leg (2);
a controller (3), connected to the table board (1), and electrically connected to the lifting mechanism;
wherein it further comprises a vibration sensor, electrically connected with the controller, and the vibration sensor is configured to sense vibration of the table board when one knocks on the table board, and the controller is configured to control the lifting mechanism to act according to the behavior that the user knocks on the table board sensed by the vibration sensor.

2. The electric lifting table of claim 1, wherein the vibration sensor is a single-axis or multi-axis acceleration sensor.

3. The electric lifting table of claim 1, wherein the vibration sensor is rigidly connected with the table board.

4. A control method of the electric lifting table, and the electric lifting table comprising:
a table board, one side of which is provided with at least one table leg;
a lifting mechanism, arranged within the table leg;
a controller, connected to the table board, and electrically connected to the lifting mechanism;
a vibration sensor, electrically connected with the controller;
wherein the controller is configured to receive vibration of the table board generated when one knocks on the table board and sensed by the vibration sensor, and then control the lifting mechanism to act in accordance with the received table board vibration generated when the user knocks on the table board.

5. The control method of the electric lifting table of claim 4, wherein it comprises the following steps:
S1, setting different control modes of the lifting mechanism corresponding to different table board vibrations as a result of different knocking modes of users;
S2, after starting control of the electric lifting table, detecting the table board vibration by the vibration sensor; if table board vibration generated when one knocks on the table board is not detected, going back to S2 to continue detecting; if table board vibration generated when one knocks on the table board is detected, transmitting table board vibration information to the controller, and then skipping to S3;
S3, acquiring a corresponding control mode of the lifting mechanism, by the controller according to the table board vibration information acquired in S2 and settings in S1, and controlling the lifting mechanism, by the controller according to the acquired control mode.

6. The control method of the electric lifting table of claim 5, wherein the table board vibration generated when one knocks on the table board in S1 is determined by detecting vibration parameters, and the vibration parameters include vibration number of times and/or frequency and/or intensity.

7. The control method of the electric lifting table of claim 5, wherein the vibration condition of the table board is set to activate the controller in S1, and S2 further comprises the following steps:
S21, detecting the table board vibration generated when one knocks on the table board by the vibration sensor; if the control mode corresponding to the detected table board vibration is just the mode for activating the controller, activating the controller, and then starting control of the electric lifting table; if the control mode corresponding to the detected table board vibration is not the mode for activating the controller, continuing detecting.

8. The control method of the electric lifting table of claim 7, wherein when no table board vibration is detected by the vibration sensor during the period of time of X since the last control behavior of the controller, the controller is controlled to be dormant, and control on the electric lifting table is closed.

9. The control method of the electric lifting table of claim 5, wherein in S2, if the vibration of the table board is detected, detection then needs to last for the period of time of Y, and then table board vibration information detected within the period of time of Y is transmitted to the controller.

10. The control method of the electric lifting table of claim 5, wherein, in S3, when the controller controls the lifting mechanism to operate, if the vibration of the table board is detected by the vibration sensor, the controller controls the lifting mechanism to stop operation.
